(19) United States
(12) Patent Application Publication
(10) Pub. No.: US 2026/0171630 A1
(43) Pub. Date: Jun. 18, 2026

(54) ALL-SOLID-STATE BATTERY

(71) Applicants: Hyundai Motor Company, Seoul (KR); Kia Corporation, Seoul (KR)

(72) Inventors: Hyun Geun KWON, Hwaseong-si (KR); Yoon Seon Kim, Hwaseong-si (KR); Sung Ju Cho, Hwaseong-si (KR)

(73) Assignees: Hyundai Motor Company, Seoul (KR); Kia Corporation, Seoul (KR)

(21) Appl. No.: 19/282,067

(22) Filed: Jul. 28, 2025

(30) Foreign Application Priority Data
Dec. 17, 2024 (KR) 10-2024-0189162

(51) Int. Cl. H01M 50/54; H01M 10/0562; H01M 10/0585; H01M 50/103; H01M 50/176; H01M 50/586; H01M 50/593

(52) U.S. Cl. CPC H01M 50/54; H01M 10/0562; H01M 10/0585; H01M 50/103; H01M 50/176; H01M 50/586; H01M 50/593

(57) ABSTRACT

All-solid-state battery includes a plurality of first electrodes each including a first electrode current collector including a first electrode body and a first electrode tab protruding from the first electrode body, a plurality of second electrodes disposed to have a different polarity from a polarity of the first electrodes and being alternately stacked with the first electrodes in a first direction, wherein each second electrode includes a second electrode current collector including a second electrode body and a second electrode tab protruding from the second electrode body, a solid electrolyte disposed between the first electrodes and the second electrodes, and a lead connected to the plurality of first electrode tabs or the plurality of second electrode tabs. The plurality of first electrode tabs and the plurality of second electrode tabs are spaced apart from each other in the first direction, and the lead includes a part joined to the plurality of first electrode tabs or the plurality of second electrode tabs and extending in the first direction.

### CROSS-REFERENCE TO RELATED APPLICATION

The present application claims the benefit of priority to Korean Patent Application No. 10-2024-0189162, filed in the Korean Intellectual Property Office on Dec. 17, 2024, the entire contents of which are incorporated herein by reference.

### TECHNICAL FIELD

The present disclosure relates to an all-solid-state battery.

### BACKGROUND

Unlike primary batteries that cannot be charged after discharging, secondary batteries which may be repeatedly charged and discharged may be applied to various fields, such as smartphones, vehicles, drones, and robots, and their importance is increasing day by day.

As a secondary battery according to a conventional technology utilizes a liquid as an electrolyte, stability deteriorates, for example, an explosion and a fire occurs when leakage occurs due to expansion due to a temperature change or an external impact, and researches and developments on all-solid-state batteries have been actively conducted to solve the present problem.

The all-solid-state battery has a high structural stability, and thus, may not need to be provide with a separator because an electrolyte located between a positive electrode coating layer and a negative electrode coating layer is formed of a solid material. Accordingly, it is possible to miniaturize the battery and further increase an energy density of the battery. However, in the all-solid-state battery, the electrode coating layer is repeatedly expanded and contracted during charging/discharging, and thus, there is a limit, for example, the interface between the electrode coating layer and the solid electrolyte is delaminated, and performance deteriorates.

To the present end, a warm isostatic press process for the all-solid-state battery may be performed to prevent the interface between the electrode coating layer and the solid electrolyte, and in the instant case, a need for a structure for preventing damage to the electrode tab of the electrode current collector during the warm isostatic press increases.

### SUMMARY

The present disclosure has been made to solve the above-mentioned problems occurring in the related art while advantages achieved by the related art are maintained intact.

An aspect of the present disclosure provides an all-solid-state battery which may prevent damage to an electrode tab during a warm isostatic press process.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an all-solid-state battery may include a plurality of first electrodes each including a first electrode current collector including a first electrode body and a first electrode tab protruding from the first electrode body, a plurality of second electrodes disposed to have a different polarity from a polarity of the first electrodes and being alternately stacked with the first electrodes in a first direction, wherein each second electrode includes a second electrode current collector including a second electrode body and a second electrode tab protruding from the second electrode body, a solid electrolyte disposed between the first electrodes and the second electrodes, and a lead connected to the plurality of first electrode tabs or the plurality of second electrode tabs, the plurality of first electrode tabs and the plurality of second electrode tabs may be spaced apart from each other in the first direction, and the lead may include a part joined to the plurality of first electrode tabs or the plurality of second electrode tabs and extending in the first direction.

The plurality of first electrode tabs may extend in the first direction from one side of the first electrode body in a second direction crossing the first direction, and the plurality of second electrode tabs may extend in the first direction from an opposite side of the second electrode body in the second direction.

End portions of the first electrode tabs may be spaced apart in the first direction from the second electrodes being adjacent to the first electrode tabs in the first direction, and end portions of the second electrode tabs may be spaced apart in the first direction from the first electrodes being adjacent to the second electrode tabs in the first direction.

The plurality of first electrode tabs may extend from the first electrode bodies in the same direction, and the plurality of second electrode tabs may extend from the second electrode bodies in the same direction.

Widths of the first electrode tabs in a third direction crossing the first direction and the second direction may correspond to widths of the first electrode bodies in the third direction, and widths of the second electrode tabs in the third direction may correspond to widths of the second electrode bodies in the third direction.

The lead may include a joining area including a section extending in the first direction to be joined to the plurality of first electrode tabs or the plurality of second electrode tabs, and a protruding area extending from the joining area.

The protruding area may extend from one end portion of the joining area in a second direction crossing the first direction.

The all-solid-state battery may further include a casing covering the plurality of first electrodes and the plurality of second electrodes, and the protruding area of the lead may pass through the casing.

The all-solid-state battery may further include an edge member extending along a circumference of the second electrode body and contacting with the second electrode body.

The edge member may include an edge hole, through which the second electrode tab passes.

The second electrode tab may protrude to an opposite side in a second direction crossing the first direction while contacting one surface of the edge member which faces the first direction.

The edge member may be formed of a polymer film.

Each first electrode may be a negative electrode, and each second electrode may be a positive electrode.

According to an aspect of the present disclosure, a method for manufacturing an all-solid-state battery may include alternately stacking at least one first electrode including a first electrode body and a first electrode tab having a width corresponding to a width of the first electrode body in a direction crossing a lengthwise direction of the first electrode body, and at least one second electrode including a second electrode body and a second electrode tab having a width corresponding to a width of the second electrode body in a direction crossing a lengthwise direction of the second electrode body, and stacking at least one solid electrolyte between the at least one first electrode and the at least one second electrode, as a unit cell stack, surrounding the stacked unit cell stack with a cover casing, and stacking the unit cell stack surrounded by the cover casing on a jig plate, and pressing the unit cell stack.

The method may further include attaching the first electrode tab of each of the stacked at least one first electrode to one side of the unit cell stack, and attaching the second electrode tab of each of the stacked at least one second electrode to an opposite side of the unit cell stack, and connecting a first lead to the attached first electrode tab of the at least one first electrode, and connecting a second lead to the attached second electrode tab of the at least one second electrode.

### BRIEF DESCRIPTION OF THE DRAWINGS

The above and other objects, features and advantages of the present disclosure will be more apparent from the following detailed description taken in conjunction with the accompanying drawings:

FIG. 1 is a vertical cross-sectional view of an all-solid-state battery according to an exemplary embodiment of the present disclosure;

FIG. 2 is a plan view of a second electrode according to an exemplary embodiment of the present disclosure;

FIG. 3 is an enlarged perspective view exemplarily illustrating a second electrode tab and a second lead portion of an all-solid-state battery according to an exemplary embodiment of the present disclosure;

FIG. 4 is a perspective view of a second lead according to an exemplary embodiment of the present disclosure; and

FIG. 5 is a flowchart of a method for manufacturing an all-solid-state battery according to an exemplary embodiment of the present disclosure.

### DETAILED DESCRIPTION

Hereinafter, various exemplary embodiments of the present disclosure will be described in detail with reference to the accompanying drawings. In adding reference numerals to the components of the drawings, it should be noted that the same components have the same numerals as possible even when they are illustrated on different drawings. Furthermore, in describing the exemplary embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

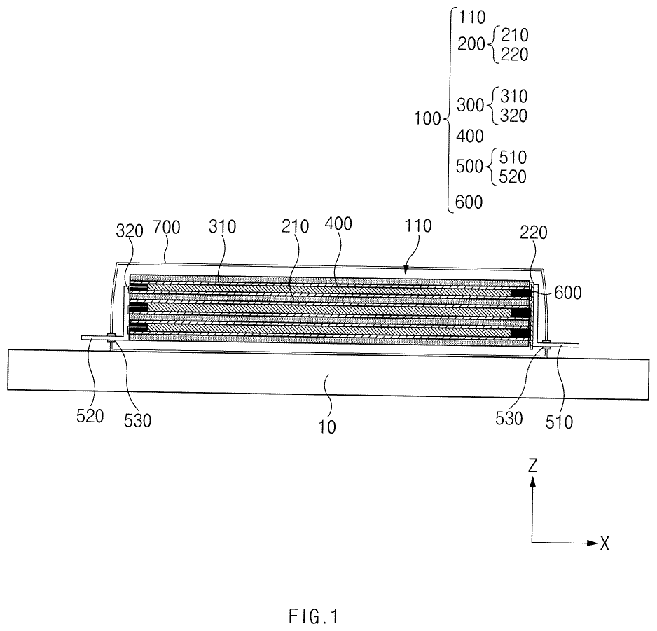

Hereinafter, various embodiments of the present disclosure will be described in detail with reference to FIGS. 1 to 5.

FIG. 1 is a vertical cross-sectional view of an all-solid-state battery according to an exemplary embodiment of the present disclosure.

Referring to FIG. 1, an all-solid-state battery 100 may include a first electrode 200, a second electrode 300, and a solid electrolyte 400 which is disposed between the first electrode 200 and the second electrode 300. At least one first electrode 200, at least one second electrode 300, and at least one solid electrolyte 400 may be defined as a unit cell stack 110.

The second electrode 300 may be stacked in the first direction (the “Z” direction or an opposite direction to the “Z” direction) of the first electrode 200 and may be disposed to have a different polarity from that of the first electrode 200. The first electrode 200 may be disposed as a negative electrode, and the second electrode 300 may be disposed as a positive electrode.

A plurality of first electrodes 200 and a plurality of second electrodes 300 may be disposed and may be alternately disposed along the first direction. Furthermore, a plurality of solid electrolytes 400 may be disposed to be stacked between the first electrodes 200 and the second electrodes 300, respectively. FIG. 1 illustrates that four first electrodes 200 are disposed, three second electrodes 300 are disposed, and six solid electrolytes 400 are disposed, but the present disclosure is not limited thereto.

The first electrode 200 may include an electrode current collector including a first electrode body 210 and a first electrode tab 220, and a first electrode coating layer which is coated on the first electrode current collector.

The second electrode 300 may include a second electrode current collector including a second electrode body 310 and a second electrode tab 320, and a second electrode coating layer which is coated on the second electrode current collector.

The first electrode coating layer may be disposed on one surface of the first electrode current collector, which faces the second electrode 300 or on opposite surfaces of the first electrode current collector in the first direction. The second electrode coating layer may be disposed on one surface of the second electrode current collector, which faces the first electrode 200 or on opposite surfaces of the second electrode current collector in the first direction.

The first electrode current collector may be formed of nickel (Ni) or may include nickel, but the present disclosure is not limited thereto. Furthermore, the second electrode current collector may be formed of aluminum (Al) or may include aluminum, but the present disclosure is not limited thereto.

The first electrode tab 220 may protrude from the first electrode body 210 to one side (the “X” direction) in the second direction. The first electrode body 210 of the first electrode current collector may be a part which is coated with the first electrode coating layer.

The second electrode tab 320 may protrude from the second electrode body 310 to an opposite side (an opposite direction to the “X” axis direction) in the second direction. The second electrode body 310 of the second electrode current collector may be a part that is coated with the second electrode coating layer.

On the other hand, unlike a lithium ion battery, the all-solid-state battery 100 may include a solid electrolyte 400 in a solid state without a separate separator between the first electrode 200 and the second electrode 300. The all-solid-state battery 100 may be manufactured by coating or transferring the solid electrolyte 400 to one surface of the second electrode 300, which faces the first electrode 200, or opposite surfaces of the second electrode 300 in the first direction.

Unlike lithium ion batteries, the particles of the solid electrolyte 400 of the all-solid-state battery 100 are provided as solid-state particles, and thus, it is necessary to form an interface between the solid electrolyte 400 and the first electrode 200 or between the solid electrolyte 400 and the second electrode 300. To the present end, the all-solid-state battery 100 may require a warm isostatic press (WIP) process.

When the warm isostatic press is applied to the all-solid-state battery 100, the all-solid-state battery 100 may be disposed on a jig plate 10. When the warm isostatic press is applied to the all-solid-state battery 100, the jig plate 10 may be configured to support the all-solid-state battery 100.

Meanwhile, when the first electrode coating layer is viewed in a state, in which it is spaced apart in the first direction, an area of the first electrode coating layer disposed in the first electrode current collector may be greater than an area of the second electrode coating layer disposed in the second electrode current collector. This may be to prevent a short circuit between the first electrode 200 and the second electrode 300 from occurring as dendrite which is a phenomenon, in which lithium crystals are disposed on the surface of the second electrode 300 and accumulated as nuclei as the all-solid-state battery 100 is repeatedly charged and discharged.

To prevent this, an area, in which the second electrode coating layer is disposed in the second electrode current collector, may be smaller than an area, in which the first electrode coating layer is disposed in the first electrode current collector. In other words, the area of the second electrode body 310 of the second electrode current collector may be smaller than the area of the first electrode body 210 of the first electrode current collector.

To compensate for a difference between the area of the first electrode coating layer and the area of the second electrode coating layer, the all-solid-state battery 100 may include an edge member 600 that extends along a circumference of the second electrode 300.

One surface of the edge member 600 may be disposed as an adhesive surface to be adhered to the second electrode current collector and the second electrode coating layer on an outside of the second electrode 300. The edge member 600 may extend along the circumference of the second electrode body 310 to contact with the second electrode body 310.

The edge member 600 may be formed of a polymer film. As an example, the edge member 600 may be formed of polyethylene terephthalate (PET), but the present disclosure is not limited thereto.

The edge member 600 may include an edge hole, through which the second electrode tab 320 passes. The edge hole may be disposed on an opposite side (in an opposite direction to the “X” direction) of the edge member 600 in the second direction. The edge hole may be disposed to correspond to the size of the second electrode tab 320, and a portion of the second electrode tab 320 may be accommodated in the edge hole.

Unlike this, the edge member 600 may not include an edge hole, and the second electrode tab 320 may protrude to an opposite side (in an opposite direction to the “X” direction) in the second direction while contacting one surface of the edge member 600, which faces the first direction.

The all-solid-state battery 100 may include a lead 500 that is connected to a plurality of first electrode tabs 220 or a plurality of second electrode tabs 320. The lead 500 may include a first lead 510 which is joined to the plurality of first electrode tabs 220 and includes a portion that extends in the first direction, and a second lead 520 which is joined to the plurality of second electrode tabs 320 and includes a portion that extends in the first direction.

The first lead 510 may be disposed on one side (the “X” direction) of the first electrode 200 in the second direction, and the second lead 520 may be disposed on an opposite side (an opposite direction to the “X” direction) of the second electrode 300 in the second direction.

The all-solid-state battery 100 may include a cover casing 700 disposed to surround the plurality of first electrodes 200, the plurality of second electrodes 300, the solid electrolyte 400, and the edge member 600 together. A portion, through which the first and second leads 510 and 520 pass, may be disposed in the cover casing 700.

Meanwhile, the cover casing 700 may be a configuration for surrounding the plurality of first electrodes 200, the plurality of second electrodes 300, the solid electrolyte 400, and the edge member 600 together before the warm isostatic press.

In the all-solid-state battery 100, the cover casing 700 may be replaced with a casing after the warm isostatic press. After the warm isostatic press, the first and second leads 510 and 520 may also pass through the casing that surrounds the plurality of first electrodes 200, the plurality of second electrodes 300, the solid electrolyte 400, and the edge member 600.

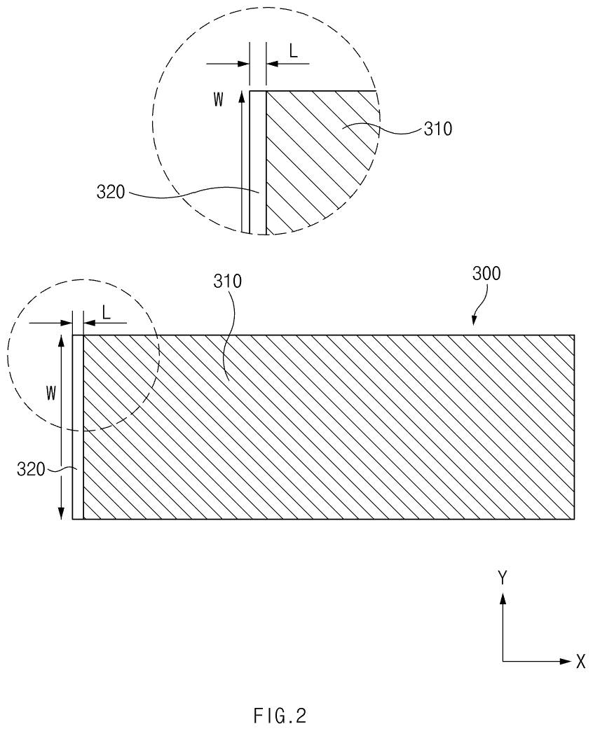

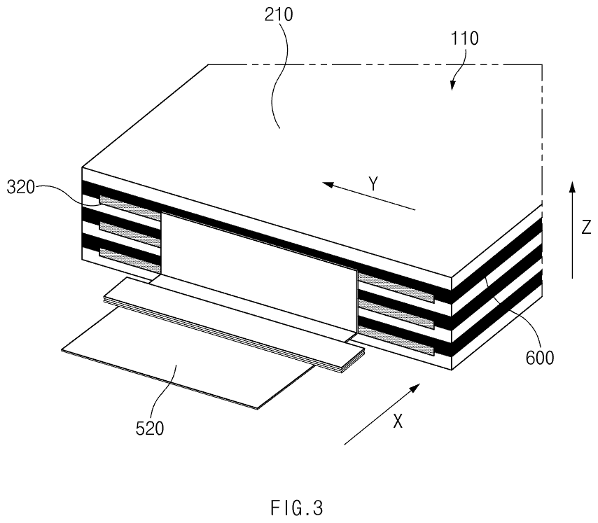

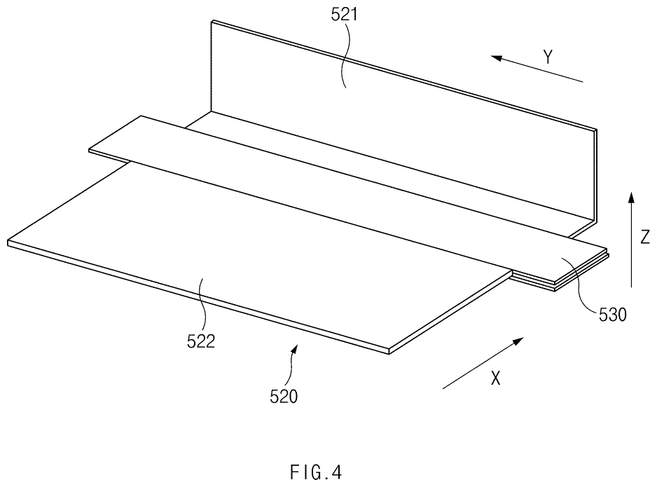

FIG. 2 is a plan view of a second electrode according to an exemplary embodiment of the present disclosure. FIG. 3 is an enlarged perspective view exemplarily illustrating a second electrode tab and a second lead portion of an all-solid-state battery according to an exemplary embodiment of the present disclosure. FIG. 4 is a perspective view of a second lead according to an exemplary embodiment of the present disclosure.

Referring to FIGS. 2 to 4, the second electrode tab 320 of the second electrode 300 may extend in parallel to the second electrode body 310 before being stacked on the first electrode 200.

As described above, the second electrode body 310 may be a portion which is coated with the second electrode coating layer, and the second electrode tab 320 may be a portion which is not coated with the second electrode coating layer.

In the instant case, the second electrode tab 320 according to an exemplary embodiment of the present disclosure protrudes from the second electrode body 310 to an opposite side (an opposite direction to the “X” direction) in the second direction, and thus, the second electrode tab 320 may be subjected to a pressure by the edge member 600 when the warm isostatic press is applied to the all-solid-state battery 100 (see FIG. 1).

In the instant case, to prevent the second electrode tab 320 from being damaged by the edge member 600 or the like, a width of the second electrode tab 320 in the third direction (the “Y” direction or an opposite direction to the “Y” direction) may correspond to a width of the second electrode body 310 in the third direction, and a length “L” of the second electrode tab 320 in the second direction may be shorter than a length of the second electrode body 310 in the second direction.

A width “W” of the second electrode tab 320 in the third direction (the “Y” direction or an opposite direction to the “Y” direction) may be formed to correspond to the width of the second electrode body 310 in the third direction. In the present way, the width W of the second electrode tab 320 in the third direction (the “Y” direction or an opposite direction to the “Y” direction) may correspond to or be smaller than the width of the second electrode body 310 in the third direction.

As an example, the length “L” of the second electrode tab 320 in the second direction may be about 2.0 mm or less. In the instant case, the length “L” of the second electrode tab 320 in the second direction may be a length before the second electrode tab 320 is bent in the first direction from the second electrode body 310.

The second electrode tab 320 according to an exemplary embodiment of the present disclosure may be manufactured while extending parallel to the second electrode body 310, and may be bent in the first direction on an opposite side (an opposite direction to the “X” direction) of the second electrode body 310 in the second direction after the second electrode 300 is stacked together with the first electrode 200.

Accordingly, the second electrode tab 320 may extend in the first direction from an opposite side (an opposite direction to the “X” direction) of the second electrode body 310 in the second direction. Furthermore, the first electrode tab 220 may extend in the first direction from one side (the “X” direction) of the first electrode body 210 in the second direction.

In a process of manufacturing the all-solid-state battery 100, the plurality of second electrode tab 320 may be bent in the first direction from the second electrode body 310 through a pressing process of the pressing plate which is moved from an opposite side (an opposite direction to the “X” direction) of the all-solid-state battery 100 (see FIG. 1) in the second direction toward one side (the “X” direction) in the second direction.

When the plurality of second electrode tabs 320 are bent in the first direction, the plurality of second electrode tabs 320 may be spaced apart from each other in the first direction.

FIGS. 1 and 3 illustrate that the plurality of second electrode tabs 320 are bent from the second electrode bodies surrounded by the edge member 600 to an opposite side (an opposite direction to the “Z” direction) in the first direction, but the present disclosure is not limited thereto, and the plurality of second electrode tabs 320 may be bent in one side (the “Z” direction) in the first direction from the second electrode body 310.

Furthermore, the plurality of second electrode tabs 320 may be bent in the same direction from the second electrode bodies 310, but some of the plurality of second electrode tabs 320 may be bent in a different direction from others of the plurality of second electrode tabs 320. For example, some of the plurality of second electrode tabs 320 may be bent from the second electrode body 310 to an opposite side (an opposite direction to the “Z” direction) in the first direction, and at the same time, some of the plurality of second electrode tabs 320 may be bent from the second electrode body 310 to one side (the “Z” direction) in the first direction.

However, one end portion of the second electrode tab 320, which faces the first direction, may be spaced apart in the first electrode 200 (see FIG. 1) that is adjacent to the second electrode tab 320 in the first direction. According to the present structure, it is possible to prevent a short circuit between the second electrode tab 320 and the first electrode 200 which is adjacent to the second electrode tab 320 from occurring.

After the plurality of second electrode tabs 320 are bent from the second electrode body 310, the second lead 520 may be welded to the plurality of second electrode tabs 320. The second lead 520 may include a joining area 521 including a section that extends in the first direction and is joined to the plurality of second electrode tabs 320, and a protruding area 522 which is bent from the joining area 521. That is, the second lead 520 may be disposed in an “L” shape.

The protruding area 522 may extend from one end portion of the joining area 521 in the first direction to an opposite side (an opposite direction to the “X” direction) in the second direction. In the instant case, one end portion of the joining area 521 in the first direction may be one end portion of the joining area 521, which faces an opposite side (an opposite direction to the “Z” direction) in the first direction.

An angle between the joining area 521 and the protruding area 522 may be 90 degrees, but may be formed at an acute angle which is smaller than 90 degrees or an obtuse angle which is greater than 90 degrees.

Each of the second electrode tabs 320 may be jointed to the joining area 521. The plurality of second electrode tabs 320 may be joined to the joining area 521 through laser welding.

When the second lead 520 is joined to the plurality of second electrode tabs 320 through laser welding, the second lead 520 may be electrically connected to all of the plurality of second electrode tabs 320 that are spaced apart from each other in the first direction.

Meanwhile, the protruding area 522 may be a portion of the second lead 520 that passes through the cover casing 700 and the casing. The protruding area 522 may be disposed with a sealing member 530 for sealing the cover casing 700 and the casing. The sealing member 530 may extend to surround the protruding area 522 to seal the portions that passes through the cover casing 700 and the casing.

In the above description, only the structures of the second electrode tab 320 and the second lead 520 have been described, but the description of the structure of the second lead 520 is used for a description of the structure of the first lead 510, and the description of the structure of the second electrode tab 320 is used for a description of the structure of the first electrode tab 220. However, a length of the joining area of the first lead 510 in the first direction may be different from a length of the joining area of the second lead 520 in the second direction.

In other words, the first electrode tab 220 of the first electrode 200 may also extend in parallel to the first electrode body 210 before being stacked together with the second electrode 300.

The width of the first electrode tab 220 in the third direction (the “Y” direction or an opposite direction to the “Y” direction) may be formed to correspond to the width of the first electrode body 210 in the third direction. The width “W” of the first electrode tab 220 in the third direction may be formed to correspond to or be smaller than the width of the first electrode body 210 in the third direction. The width of the first electrode tab 220 in the third direction may be the same as the width of the first electrode body 210 in the third direction.

For example, the length of the first electrode tab 220 in the second direction may be provided to be smaller than approximately 2.0 mm. In the instant case, the length of the first electrode tab 220 in the second direction may be a length before the first electrode tab 220 is bent in the first direction from the first electrode body 210.

The first electrode tab 220 may be bent in the first direction from one side (the “X” direction) of the first electrode body 210 in the second direction after the first electrode 200 is stacked together with the second electrode 300. The plurality of first electrode tabs 220 may be spaced apart from each other in the first direction.

In a process of manufacturing the all-solid-state battery 100, the plurality of first electrode tabs 220 may be bent from the first electrode body 210 in the first direction (the “Z” direction or an opposite direction to the “Z” direction) by a pressing process of the pressing plate which is moved from one side (the “X” direction) of the all-solid-state battery 100 in the second direction to an opposite side (an opposite direction to the “X” direction) in the second direction (the “X” direction).

When the plurality of first electrode tabs 220 are bent in the first direction, the plurality of first electrode tabs 220 may be spaced apart from each other in the first direction.

FIG. 1 illustrates that each of the first electrode tabs 220 is bent from the first electrode body 210 to an opposite side (an opposite direction to the “Z” direction) in the first direction, like the plurality of second electrode tabs 320, the present disclosure is not limited thereto, and the plurality of first electrode tabs 220 may be bent from the first electrode body 210 to one side (the “Z” direction) in the first direction.

Furthermore, the plurality of first electrode tabs 220 may be bent in the same direction from the first electrode tabs 210, but some of the plurality of first electrode tabs 220 may be bent in a different direction from others of the plurality of first electrode tabs 220. For example, some of the plurality of first electrode tabs 220 may be bent from the first electrode body 210 to an opposite side (an opposite direction to the “Z” direction) in the first direction, and at the same time, some of the plurality of first electrode tabs 220 may be bent from the first electrode body 210 to one side (the “Z” direction) in the first direction.

However, one end portion of the first electrode tab 220, which faces the first direction, may be spaced apart in the second electrode 300 which is adjacent to the first electrode tab 220 in the first direction. According to the present structure, it is possible to prevent a short circuit between the first electrode tab 220 and the second electrode 300 which is adjacent to the first electrode tab 220 from occurring.

After the plurality of first electrode tabs 220 are bent from the first electrode body 210, the first lead 510 may be welded to the plurality of first electrode tabs 220. Like the second lead 520, the first lead 510 may also include a joining area including a section that extends in the first direction and is joined to the plurality of first electrode tabs 220 and a protruding area which is bent from one end portion of the joining area, which faces an opposite side (an opposite direction to the “Z” direction) in the first direction and extends to one side (the “X” direction) in the second direction. Like the second lead 520, the first lead 510 may be formed in an “L” shape.

An angle between the joining area and the protruding area of the first lead 510 may be 90 degrees, but may be formed at an acute angle which is smaller than 90 degrees or an obtuse angle which is greater than 90 degrees.

When the plurality of first electrode tabs 220 are joined to the joining area of the first lead 510 through laser welding, the first lead 510 may be electrically connected to all of the plurality of first electrode tabs 220 that are spaced apart from each other in the first direction.

The protruding area of the first lead 510 may also be a portion of the first lead 510, which passes through the cover casing 700 and the casing. Accordingly, a sealing member 530 for sealing the cover casing 700 and the casing may be disposed in the protruding area of the first lead 510. The sealing member 530 may extend to surround the protruding area of the first lead to seal the portions that passes through the cover casing 700 and the casing.

According to the above-described structure, the width of the first electrode tab 220 of the all-solid-state battery 100 may be formed to correspond to or be smaller than the width of the first electrode body 210. Furthermore, the width “W” of the second electrode tab 320 may be formed to correspond to or be smaller than the width of the second electrode body 310. Because the size of the first electrode body 210 is greater than the size of the second electrode body 310, the width of the first electrode tab 220 may be greater than the width of the second electrode tab 320.

Furthermore, the first and second electrode tabs 220 and 320 may be bent from the first and second electrode bodies 210 and 310 from opposite sides (the “X” direction or an opposite direction to the “X” direction) in the second direction to the first direction, respectively.

In the present state, the plurality of first and second electrode tabs 220 and 320 may be electrically connected to each other by the first and second leads 510 and 520 while being spaced apart from each other in the first direction.

According to the structure, even when the warm isostatic press is applied to the all-solid-state battery 100, damage to a portion of the first and second electrode tabs 220 and 320, to which pressure is applied in the first direction, may be prevented.

Therefore, the productivity and usability of the all-solid-state battery 100 may be improved because a defect rate of the first and second electrode tabs 220 and 320 itself may be reduced or an electrical connection between the first and second electrode tabs 220 and 320 and the first and second leads 510 and 520 may be stably maintained.

To support this, an exemplary embodiment of the present disclosure, a comparative example, and an experimental example were conducted as follows.

### Embodiment

An all-solid-state battery 100 having a width “W” of the second electrode tab 320 in the third direction of 80 mm and a length “L” of the second electrode tab 320 in the second direction of 2 mm was manufactured. A width “W” of the second electrode body 310 in the third direction may be provided to be 80 mm.

### Comparative Example

An all-solid-state battery having a width of the second electrode tab in the third direction of 45 mm and a length of the second electrode tab in the second direction of 22 mm was manufactured.

### Experimental Example

A warm isostatic press process was applied to twenty all-solid-state batteries according to the exemplary embodiment and the comparative example. In the instant case, when the warm isostatic pressure process was applied to each of the twenty embodiments and the twenty comparative examples, the numbers of the exemplary embodiments and the comparative examples, in which damage occurred, among the twenty second electrode tabs 320 of the exemplary embodiments and the twenty second electrode tabs of the comparative examples were measured.

In the case of the embodiments, the number of damages to the second electrode tabs 320 in the twenty all-solid-state batteries 100 was measured to be 0.

Unlike this, in the case of the comparative examples, among all-solid-state batteries, the number of second electrode tab that broke was 16, and the defect rate was measured to be 80%.

As may be seen from the experimental results, it may be identified that the defect rate of the all-solid-state batteries 100 according to the exemplary embodiments is significantly reduced, compared to the comparative examples.

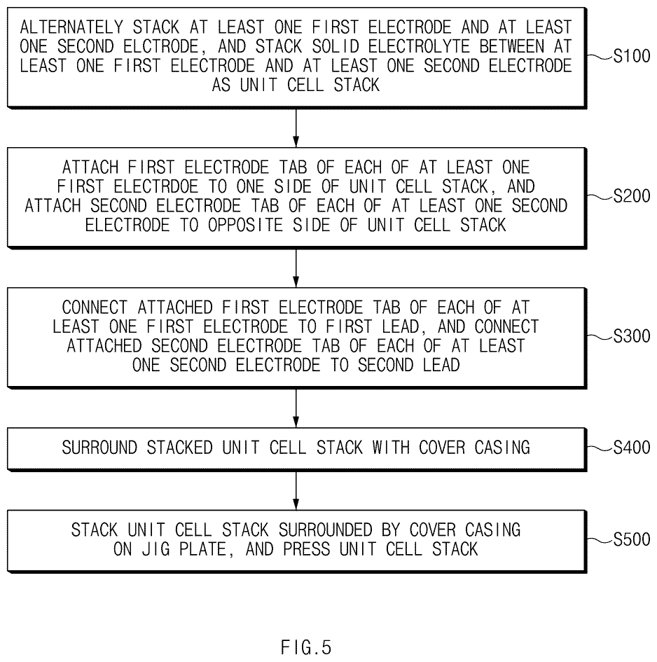

FIG. 5 is a flowchart of a method for manufacturing an all-solid-state battery according to an exemplary embodiment of the present disclosure.

Referring to FIGS. 1 and 5, the method for manufacturing the all-solid-state battery 100 according to an exemplary embodiment of the present disclosure may include an operation S100 of stacking at least one first electrode 200 and at least one second electrode 300, and stacking a solid electrolyte 400 as a unit cell stack 110 together between the at least one first electrode 200 and the at least one second electrode 300.

In the instant case, the at least one first electrode 200 may include a first electrode body 210, and a first electrode tab 220 which is connected to the first electrode body 210. A width of the first electrode body 210 in the third direction (the “Y” direction or an opposite direction to the “Y” direction) may correspond to a width of the first electrode tab 220 in the third direction.

Furthermore, the at least one second electrode 300 may include a second electrode body 310, and a second electrode tab 320 which is connected to the second electrode body 310. A width of the second electrode body 310 in the third direction may correspond to a width of the second electrode tab 320 in the third direction.

The method for manufacturing the all-solid-state battery 100 according to an exemplary embodiment of the present disclosure may include an operation S200 of attaching the first electrode tab 220 of each of the at least one first electrode 200 to one side of the unit cell stack 110, and attaching the second electrode tab 320 of each of the stacked at least one second electrode 300 to an opposite side of the unit cell stack 110.

In the instant case, the first electrode tab 220 may be attached to one side (the “X” direction) of the unit cell stack 110 in the second direction, and the second electrode tab 320 may be attached to an opposite side (an opposite direction to the “X” direction) of the unit cell stack 110 in the second direction.

The method for manufacturing the all-solid-state battery 100 according to an exemplary embodiment of the present disclosure may further include an operation S300 of connecting the attached first electrode tab 220 of the at least one first electrode 200 to a first lead 510, and connecting the attached second electrode tab 320 of the at least one second electrode 300 to a second lead 520.

In the instant case, the first lead 510 may be attached to one side (the “X” direction) of the unit cell stack 110 in the second direction to be electrically connected to all of the at least one first electrode tab 220. Furthermore, the second lead 520 may be attached to an opposite side (an opposite direction to the “X” direction) of the unit cell stack 110 in the second direction to be electrically connected to all of the at least one second electrode tab 320.

The method for manufacturing the all-solid-state battery 100 according to an exemplary embodiment of the present disclosure may further include an operation S400 of surrounding the stacked unit cell stack 110 with a cover casing 700.

The method for manufacturing the all-solid-state battery 100 according to an exemplary embodiment of the present disclosure may include an operation S500 of stacking the surrounded unit cell stack 110 on a jig plate 10, and pressing the unit cell stack 110. In the instant case, the pressing process of the unit cell stack 110 may be performed by the warm isostatic press.

In the all-solid-state battery 100 according to an exemplary embodiment of the present disclosure, the first electrode body 210 and the first electrode tab 220 may include the same width in the direction which is perpendicular to the longitudinal direction of the first electrode body 210, and the second electrode body 310 and the second electrode tab 320 may have the same width in the direction which is perpendicular to the longitudinal direction of the second electrode body 310, and thus, the first and second electrode tabs 220 and 320 may be attached to opposite sides of the unit cell stack 110.

The first and second electrode tabs 220 and 320 are connected to the first and second leads 510 and 520 while being attached to each other on opposite sides of the unit cell stack 110, and thus, damage to the first and second electrode tabs 220 and 320 may be prevented during the warm isostatic press of the unit cell stack 110. Accordingly, the productivity of the all-solid-state battery 100 may be improved.

According to the present technology, when a warm isostatic press process is performed on the all-solid-state battery, damage to an electrode tab of an electrode current collector may be prevented, so that the productivity of the all-solid-state battery may be improved.

Furthermore, according to the present technology, because a short circuit between the electrode tab of the electrode current collector and the lead may be prevented, the durability of the all-solid-state battery may be improved.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. An all-solid-state battery comprising:
a plurality of first electrodes, wherein each first electrode includes a first electrode current collector including a first electrode body and a first electrode tab protruding from the first electrode body;
a plurality of second electrodes disposed to have a different polarity from a polarity of the first electrodes and being alternately stacked with the first electrodes in a first direction, wherein each second electrode includes a second electrode current collector including a second electrode body and a second electrode tab protruding from the second electrode body;
a solid electrolyte disposed between the first electrodes and the second electrodes; and
a lead connected to the plurality of first electrode tabs or the plurality of second electrode tabs,
wherein the plurality of first electrode tabs and the plurality of second electrode tabs are spaced apart from each other in the first direction, and
wherein the lead includes a part joined to the plurality of first electrode tabs or the plurality of second electrode tabs and extending in the first direction.

2. The all-solid-state battery of claim 1,
wherein the plurality of first electrode tabs extend in the first direction from one side of the first electrode body in a second direction crossing the first direction, and
wherein the plurality of second electrode tabs extend in the first direction from an opposite side of the second electrode body in the second direction.

3. The all-solid-state battery of claim 2,
wherein end portions of the first electrode tabs are spaced apart in the first direction from the second electrodes being adjacent to the first electrode tabs in the first direction, and
wherein end portions of the second electrode tabs are spaced apart in the first direction from the first electrodes being adjacent to the second electrode tabs in the first direction.

4. The all-solid-state battery of claim 2,
wherein the plurality of first electrode tabs extend from the first electrode bodies in the same direction, and
wherein the plurality of second electrode tabs extend from the second electrode bodies in the same direction.

5. The all-solid-state battery of claim 2,
wherein widths of the first electrode tabs in a third direction crossing the first direction and the second direction correspond to widths of the first electrode bodies in the third direction, and
wherein widths of the second electrode tabs in the third direction correspond to widths of the second electrode bodies in the third direction.

6. The all-solid-state battery of claim 1, wherein the lead includes:
a joining area including a section extending in the first direction to be joined to the plurality of first electrode tabs or the plurality of second electrode tabs, and
a protruding area extending from the joining area.

7. The all-solid-state battery of claim 6, wherein the protruding area extends from one end portion of the joining area in a second direction crossing the first direction.

8. The all-solid-state battery of claim 6, further comprising:
a casing covering the plurality of first electrodes and the plurality of second electrodes,
wherein the protruding area of the lead passes through the casing.

9. The all-solid-state battery of claim 1, further comprising:
an edge member extending along a circumference of the second electrode body and contacting with the second electrode body.

10. The all-solid-state battery of claim 9, wherein the edge member includes an edge hole, through which the second electrode tab passes.

11. The all-solid-state battery of claim 9, wherein the second electrode tab protrudes to an opposite side in a second direction crossing the first direction while contacting one surface of the edge member which faces the first direction.

12. The all-solid-state battery of claim 10, wherein the edge member is formed of a polymer film.

13. The all-solid-state battery of claim 1, wherein each first electrode is a negative electrode, and each second electrode is a positive electrode.

14. A method for manufacturing an all-solid-state battery, the method comprising:
alternately stacking at least one first electrode including a first electrode body and a first electrode tab having a width corresponding to a width of the first electrode body in a direction crossing a lengthwise direction of the first electrode body, and at least one second electrode including a second electrode body and a second electrode tab having a width corresponding to a width of the second electrode body in a direction crossing a lengthwise direction of the second electrode body, and stacking at least one solid electrolyte between the at least one first electrode and the at least one second electrode, as a unit cell stack;
surrounding the stacked unit cell stack with a cover casing; and
stacking the unit cell stack surrounded by the cover casing on a jig plate, and pressing the unit cell stack.

15. The method of claim 14, further comprising:
attaching the first electrode tab of each of the stacked at least one first electrode to one side of the unit cell stack, and attaching the second electrode tab of each of the stacked at least one second electrode to an opposite side of the unit cell stack; and
connecting a first lead to the attached first electrode tab of the at least one first electrode, and connecting a second lead to the attached second electrode tab of the at least one second electrode.
